(19) United States
(12) Patent Application Publication
(10) Pub. No.: US 2009/0169854 A1
(43) Pub. Date: Jul. 2, 2009

(54) Porous Member

(76) Inventors: Tadahiro Ohmi, Miyagi (JP); Yukio Kishi, Miyagi (JP); Mabito Iguchi, Miyagi (JP); Yoshitaka Ichikawa, Miyagi (JP); Yusuke Komatsu, Miyagi (JP)

Correspondence Address: FOLEY AND LARDNER LLP;SUITE 500, 3000 K STREET NW, WASHINGTON, DC, 20007, US

(21) Appl. No.: 12/225,696

(22) PCT Filed: Mar. 29, 2007
(86) PCT No.: PCT/JP2007/056803

§ 371 Date: Sep. 26, 2008

(30) Foreign Application Priority Data
Mar. 13, 2006 (JP) 2006-098093

(51) Int. Cl. C04B 35/01; C04B 33/02

(52) U.S. Cl. 428/221; 156/89.28

(57) ABSTRACT

To provide a porous member that can suppress energy loss in a microwave band and can evenly disperse gas when used in a field requiring a high level of cleanness. The porous member is formed of porous ceramics and has a dielectric loss tangent of not more than 1×10⁻³ in a microwave band. A ceramic member has sintered ceramics including the porous member at a part thereof.

### TECHNICAL FIELD

The present invention relates to a porous member used as a part or a member for use in an environment requiring energy saving and uniform gas flow rate, such as in dry process of electronic devices, production of medical products, and processing and production of foods.

### BACKGROUND ART

For semiconductors, refinement of a design rule has proceeded along with improvement of integration degree and it has been demanded to reduce and decrease permissible extent and amount of contamination due to deposits and metals.

On the other hand, in an apparatus for manufacturing semiconductors, a plasma exciting system by microwaves has been adopted for making the efficiency higher. Further, also in the field of medical products and foods, microwaves have been adopted in a step, such as drying. Usually, ceramics have been adopted in those structures for which contamination of metals, etc. is not desired.

As semiconductor manufacturing apparatus, microwave plasma processing apparatus will be described by way of an example. Porous materials have been adopted for members such as for gas dispersion. The material is provided with a number of through holes which are formed, for example, at intervals of several millimeters as disclosed, for example, in Patent Document 1.

However, since a process gas passing therethrough, after all, passes through the through holes formed in the member, the contact state of gas is not always uniform on a silicon wafer exposed to the gas. This results in lowering of the yield of semiconductor products. Therefore, it has been proposed to use a porous material, for example, as in Patent Document 2.

However, in those parts using existent porous members, high dielectric loss tangent of the materials results in loss of microwaves, instability of plasma and, thus, low yield of semiconductor products. Further, since the porosity and the pore diameter are not controlled sufficiently, it is difficult to stably control the gas flow rate.

Patent Document 1: JP-A-2003-133237

Patent Document 2: JP-A-2003-045809

### DISCLOSURE OF THE INVENTION

### The Problem to be Solved by the Invention

The present invention has been made in view of the foregoing drawbacks and an object of the invention is to provide a porous member that can suppress energy loss in a microwave band and can evenly disperse a gas when used in a field requiring a high level of cleanness.

It is another object of the invention to provide a method of manufacturing the porous member.

It is still another object of the invention to provide a ceramic member comprising sintered ceramics integrally having the porous member.

It is yet another object of the invention to provide a method of manufacturing the ceramic member.

### Means Undertaken to Solve the Problem

Then, in view of the foregoing objects, the present inventors have found that it is important in the porous member that a constituent member has a dielectric loss tangent of 1×10⁻³ or lower in a microwave band in order to suppress the energy loss in a microwave band and to avoid fracture due to local heating, and that there is an appropriate range of porosity, pore diameter, and pressure loss for-uniform gas dispersion. As a result, the present invention has been accomplished.

A porous member according to the present invention is formed of porous ceramics and has a dielectric loss tangent of 1×10⁻³ or less in a microwave band.

In the porous member according to the present invention, it is preferable that the open porosity is from 15 to 60%, the average pore diameter is 100 μm or less, the pressure loss is 133 Pa or higher at a flow rate of 1 to 10 cc/min/cm², or the porous member contains at least one of oxides of Al, Si, and Y.

A ceramic member according to the present invention has sintered ceramics comprising a porous member formed of porous ceramics and having a dielectric loss tangent of 1×10⁻³ or less in a microwave band.

In the present invention, it is preferable that the porous member has an open porosity of from 15 to 60%, that the porous member has an average pore diameter of 100 μm or less, that the porous member has a pressure loss of 133 Pa or higher at a flow rate of 1 to 10 cc/min/cm², or that the porous member contains at least one of oxides of Al, Si, and Y.

A method of manufacturing a porous member according to the present invention includes blending a starting ceramic powder with an average particle diameter of 1 to 300 μm and a bonding material comprising glass at a blending ratio of 100:15 to 100:60 by weight to prepare a slurry and burning the same at 1550° C. to 1700° C.

### EFFECT OF THE INVENTION

The present invention can provide a porous member that can suppress the energy loss in a microwave band and can uniformly disperse a gas when used in a field of requiring a high level of cleanness, a manufacturing method thereof, and a ceramic member using the same, as well as a manufacturing method thereof.

### BRIEF DESCRIPTION OF THE DRAWINGS

FIG. 1 is a view used for explanation of a method of measuring pressure loss.

FIG. 2 is a view showing evaluation for fracture due to microwaves.

FIG. 3 is a view used for evaluation of gas dispersibility.

### DESCRIPTION OF REFERENCES

1 porous member (porous material)
2 fixing member
6 gas flow-in pipe
7 gas flow-out pipe
8 conductance
9 exhaust pump
10 gas pipeline
11, 12 pressure meter
13 mass flow meter
15 gas
16 pipeline
20 pressure loss
21 arrow
30 fracture evaluation device
31 casing
32 diffusion blade
33 rotary shaft
34 driving section
35 diffusion blade rotating device
36 output section
37 main body
38 microwave generator
40 gas dispersion evaluation apparatus
41 casing
42 lid member
43 gas introduction hole
44 support section (integrated product of porous material and ceramics)
45 support section (member allowing microwaves to transmit therethrough)

### BEST MODE FOR CARRYING OUT THE INVENTION

The present invention will be described more in detail.

For a porous member of the invention, it is important that the dielectric loss tangent is 1×10⁻³ or lower and, more preferably, 5×10⁻⁴ or lower. The reason is as follows. In this invention, in case where the dielectric loss tangent is higher than 1×10⁻³, energy loss in a microwave band and fracture due to local heating are caused to occur. This is not preferable as a constituent member.

Further, the porous member has an open porosity within a range from 15 to 60%, preferably, from 20 to 30%. This is because gas permeability lowers remarkably in a region where the open porosity is below 15%, whereas pressure loss is lowered to lower the uniform dispersibility of a gas in a range exceeding 60%. Accordingly, this is not preferable as a member, such as for semiconductors or medical products and foods.

Similarly, it is necessary for the porous member that the average pore diameter is 100 μm or less, preferably, 50 μm or less, more preferably, from 10 to 25 μm. This is because uniform jetting of a gas, gaseous material becomes extremely difficult when the average pore diameter exceeds 100 μm.

Further, the pressure loss is 133 Pa or higher at a flow rate of from 1 to 10 cc/min/cm². This is because no sufficient gas dispersion effect is obtainable and local gas blowing occurs in case where the pressure loss is below 133 Pa.

Then, description will be made as regards an example of a method of manufacturing the porous member.

As a starting material, an alumina powder and quartz glass are prepared. The alumina powder having a high purity and an average particle diameter of 30 μm, and quartz glass having a high purity like alumina (99% or higher) and an average particle diameter of 5 μm were used.

Since the purity of the starting material, particularly, an alkali metal gives a significant effect on the dielectric loss tangent, it is desired that the amount, for example, of Na or K is smaller.

Further, when the average particle diameter of the starting material is excessively small, gas permeability is difficult to obtain. When it is excessively large, pressure loss sufficient for gas dispersion is not obtained. Therefore, the average particle diameter of the staring material is preferably about from 1 to 300 μm, more preferably, about from 10 to 25 μm. The quartz glass is used as a bonding material. Therefore, if it is coarse, it is less fusible, and cannot maintain the effect as the bonding material. Preferably, the average particle diameter thereof is about from 1 to 10 μm.

Alumina and quartz glass were mixed at a blending ratio of 100:15 to 100:60. Further, a desired organic molding aid, such as a dispersant and PVA, is added and mixed to form a slurry. The slurry is filled in sintered ceramics and burned at 1550° C. to 1170° C. In burning, it is desired to flow a sufficient amount of air through a furnace. In this manner, an integral product of a porous and dense ceramics is formed.

In case where the blending ratio of alumina and quartz glass is excessively small, the material strength is lowered. If the blending ratio is excessively large, pores are closed to lose the gas permeability. Therefore, the ratio is preferably about from 100:15 to 100:60, more preferably, about from 100:30 to 100:45.

Alternatively, the slurry may be cast into a filling mold of high water absorption such as gypsum, solidified and molded, thereafter mold-released, and subjected to burning including dewaxing to form porous ceramics. Then, by bonding the dense ceramics and the porous ceramics, an integral product of the porous and the dense ceramics is formed.

Bonding may be conducted, for example, by a green sheet capable of forming a bonding layer and interposed at the boundary between the porous ceramics and the dense ceramics. Alternatively, a slurry forming a bonding layer is applied to the porous ceramic portion, thereafter filled in the dense ceramics and burned. Not being limited to the manufacturing method described above, any method may be used, for example, an alumina powder and a pore forming agent, such as a graphite powder or resin beads may be added, so long as a porous material having predetermined porosity, pore diameter, and pressure loss are obtained.

The porous ceramics obtained as described above have a sufficient strength for fabrication. Even in an environment such that heat is applied in a corrosive gas or plasma thereof, they can be used stably without suffering from fracture by thermal impact or without generation of local heating by the application of microwaves.

In the invention, it is desired that the dielectric loss tangent is 5×10⁻⁴ or less, the porosity is from 20 to 30%, and the pore diameter is from 10 to 25 μm.

### EXAMPLES

Examples of the invention will be described below. In the following examples, Examples 1 to 4 are more preferable. However, it will be apparent that the invention is not restricted to those examples.

For the starting material used for manufacturing the porous member of the invention, type/purity/particle diameter of the material particles and type of the bonding material/blending ratio with the material particles are shown in the following Table 1. The type of the material particles includes alumina, quartz, and yttria, the purity is 99% or higher, and the particle diameter is from 1 to 300 μm. As the bonding material, quartz with the purity of 99% or higher or non-alkali glass with less alkali ingredient was used.

Material particles and the bonding material were weighed at a predetermined ratio. A mixed slurry of the material particles and the bonding material was prepared in an ion-exchange water by a ball mill using resin balls. The slurry was cast into a mold of □200×t 50 mm formed of alumina and the slurry was stood still. After removing supernatants (ion exchange water) in the upper portion of the slurry, drying and mold-releasing were carried out. Thus, a molding product was produced.

The molding product was burned by a resistance heating furnace in an atmospheric air to produce a porous member. Characteristics of the obtained porous member were measured by the following apparatus and method.

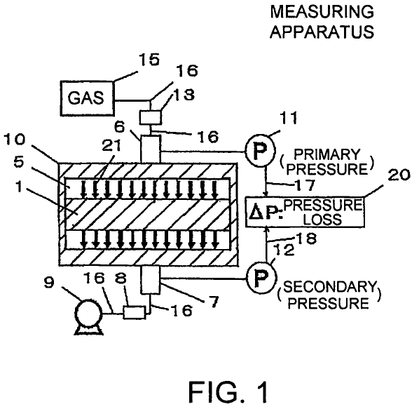

FIG. 1 is a schematic constitutional view of a measuring apparatus for use in describing a measuring method of pressure loss. As shown in the figure, the measuring apparatus has a gas pipeline 10 connected with a vacuum chamber.

The gas pipeline 10 has a gas flow-in pipe 6 and a gas flow-out pipe 7. A gas 15 is connected via a mass flow meter 13 through a pipeline 16 to the gas flow-in pipe 6. The gas flow-out pipe 7 is connected via a conductance 8 to an exhaust pump 9 through the pipeline 16.

A primary pressure gauge 11 for measuring a primary pressure P1 as a flow-in pressure to the gas pipeline 10 is connected with the gas flow-in pipe 6. On the other hand, a secondary pressure gauge 12 for measuring a secondary pressure P2 as a flow-out pressure from the gas pipeline 10 is connected with the gas flow-out pipe 7. A measurement specimen (porous material) of the porous member 1 is disposed in a space 5 in the inside of the gas pipeline 10. The gas is introduced and discharged as shown by arrows 21. From the difference: P1−P2=ΔP between a primary pressure measured value (output) 17 and a secondary pressure measured value (output) at this time, a pressure loss (ΔP) 20 is obtained by a differential amplifier or the like. The measurement may be conducted also by a measuring device using a computer.

The measuring conditions are as follows. The type of the flow gas is Ar, the flow rate of the flow gas is from 0.1 to 3 cc/min/cm², the primary pressure P1 is from 133 Pa to 267 hPa, the secondary pressure P2 is 7 Pa, the measuring temperature is a normal temperature, and the T/P shape is: diameter (φ) 42×thickness (t)10 mm.

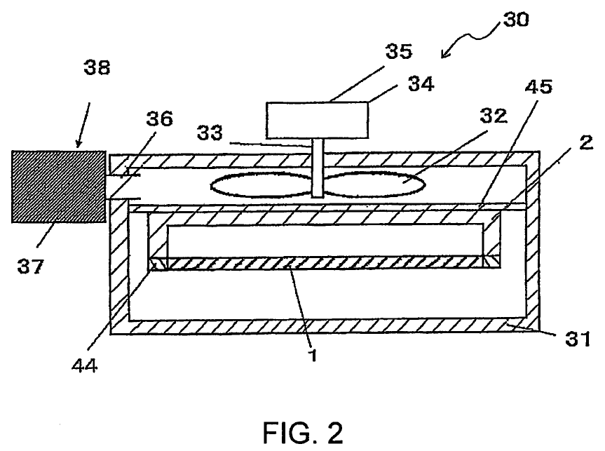

FIG. 2 is a schematic constitutional view of an apparatus used for fracture evaluation by microwaves. Referring to FIG. 2, a fracture evaluation device 30 has a casing 31 made of stainless steel, a diffusion blade rotating device 35 disposed at the outside of the casing for rotating a diffusion blade 32 in the casing via a rotary shaft passing through a wall portion, and a microwave generator 38 having an output section 36 for supplying microwaves (for example, 2.45 GHz) into the casing and a main body 37 disposed at the outside of the casing 31.

In the casing 31, a fixing member 2 for fixing a support part 44 integral with a specimen of the porous member 1 having a diameter (φ) of 300 mm×thickness (t) of 10 mm, and a support part 45 having a member supporting the fixing member in the casing and allowing microwaves to transmit therethrough are disposed.

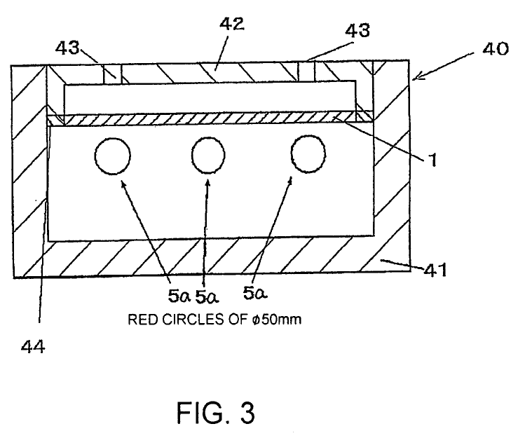

FIG. 3 is a schematic cross sectional view showing a constitution of a device for evaluating gas dispersion. As shown in FIG. 3, the gas dispersion evaluation device 40 comprises a casing 41 made of stainless steel and a cover member 42 disposed so as to close the upper opening of the casing. A porous member 1 having a diameter (φ) 300×thickness (t) 10 mm is disposed so as to close an area between lower ends of the side wall of the cover member 42. The porous material is integral with ceramics of the support part 44. A plurality of gas introduction holes 43 are formed on the ceiling surface of the cover member. On the inner wall, red circles each having a diameter (φ) of 50 mm are arranged horizontally at equal intervals. The near side is in an opened state so that the inside can be viewed.

Then, measuring method for each of characteristics will be described.

(i) Dielectric loss tangent: In order to measure the dielectric loss tangent in microwave bands of 2 and 3 GHz, the obtained porous material was processed by grinding into a shape of □1.5×L 100 mm. Measurement was made by a network analyzer 8791 ES device manufactured by AGILEMT TecH. by a perturbation method using a cavity resonator.

(ii) Open porosity: A porous material of about □130×t 10 mm was measured by an Archimedes method (JIS R 1634).

(iii) Average pore diameter: A porous material of about □5×t 5 mm was measured by a mercury penetration method (JIS R 1655).

(iv) Pressure loss: As shown in FIG. 1, a porous material 1 processed by grinding into a shape of diameter (φ) 42×thickness (t) 10 mm was fixed in the inside 5 of the gas pipeline 10 connected with a vacuum chamber. The inside 5 of the gas pipeline was once evacuated. Then, an Ar gas was caused to flow from the upstream side in the state where the downstream side is evacuated. A difference between the pressure on the upstream side (primary pressure P1) and a pressure on the downstream side (secondary pressure P2) was measured. The difference ΔP was defined as a pressure loss 20. The gas flow rate was set to 1 cc/min/cm².

A bonding material identical with the porous member 1 was applied to the obtained porous member 1 at the joined portion with the dense material. Heat treatment was carried out again to conduct bonding.

As shown in FIG. 2, the obtained ceramic member was attached to the evaluation apparatus. By the microwave generator at 2.45 GHz, microwaves at a power of 600 W were applied for 30 minutes. Then, presence or absence of fracture caused by local heating was confirmed.

Further, as shown in FIG. 3, by flowing dry ice at 1 to 100 cc/min/cm², whether or not white smoke was discharged uniformly from the porous member 1 was confirmed by means of visibility of the red circles 5 marked on the casing. Thus, whether or not gas dispersion was uniform was confirmed.

The obtained results are shown in the following Table 1.

[Table 1]

TABLE 1

| | porous material | | | | | | | |
|---|---|---|---|---|---|---|---|---|
| | material particle | | | | | | | |
| | | | average | | material particle: | | | |
| | | | particle | | bonding material | baking | dielectric loss | |
| | | purity | diameter^{2} | | blend ratio | temperature | tangent × 10⁻⁴ | |
| | type | (%) | (μm) | type of bonding material | (wt %) | (° C.) | 2 GHz | 3 Ghz |
| Example 1 | alumina | 99.99 | 30 | quartz at 99.99% purity | 100:15 | 1600 | 1 | 4 |
| Example 2 | alumina | 99.99 | 30 | quartz at 99.99% purity | 100:30 | 1600 | 1 | 4 |
| Example 3 | alumina | 99.99 | 30 | quartz at 99.99% purity | 100:45 | 1600 | 1 | 4 |
| Example 4 | alumina | 99.99 | 30 | quartz at 99.99% purity | 100:60 | 1600 | 1 | 4 |
| Example 5 | alumina | 99.99 | 200 | quartz at 99.99% purity | 100:30 | 1600 | 1 | 4 |
| Example 6 | alumina | 99.99 | 110 | quartz at 99.99% purity | 100:30 | 1600 | 1 | 4 |
| Example 7 | alumina | 99.99 | 60 | quartz at 99.99% purity | 100:30 | 1600 | 1 | 4 |
| Example 8 | alumina | 99 | 34 | quartz at 99.99% purity | 100:30 | 1600 | 4 | 7 |
| Example 9 | alumina | 99 | 110 | quartz at 99.99% purity | 100:30 | 1600 | 4 | 7 |
| Example 10 | alumina | 99.99 | 30 | non-alkali glass (alkali metal 0.4%) | 100:30 | 1000 | 5 | 8 |
| Example 11 | alumina | 99 | 34 | non-alkali glass (alkali metal 0.4%) | 100:30 | 1000 | 4 | 9 |
| Example 12 | alumina | 99.99 | 1 | non-alkali glass (alkali metal 0.4%) | 100:15 | 1000 | 5 | 9 |
| Example 13 | alumina | 99.99 | 1 | — | — | 1600 | 1 | 4 |
| Example 14 | quartz | 99.99 | 110 | — | — | 1600 | 1 | 3 |
| Example 15 | yttria | 99.99 | 5 | — | — | 1700 | 1 | 4 |
| Example 16 | yttria | 99 | 30 | quartz at 99.99% purity | 100:30 | 1600 | 1 | 4 |
| Example 17 | yttria | 99 | 30 | non-alkali glass (alkali metal 0.4%) | 100:30 | 1000 | 2 | 5 |
| Comp. Ex. 1 | alumina | 99.99 | 30 | alkali glass (alkali metal, 2%)*³ | 100:30 | 900 | 7 | 16^{3} |
| Comp. Ex. 2 | alumina | 99 | 0.4^{3} | non-alkali glass (alkali metal 0.4%) | 100:30 | 1000 | 4 | 8 |
| Comp. Ex. 3 | alumina | 96.5^{3} | 110 | quartz at 99.99% purity | 100:30 | 1600 | 8 | 16^{3} |
| Comp. Ex. 4 | alumina | 99 | 1000^{3} | quartz at 99.99% purity | 100:30 | 1600 | 3 | 7 |
| Comp. Ex. 5 | alumina | 99 | 1000^{3} | quartz at 99.99% purity | 100:45 | 1600 | 4 | 7 |
| Comp. Ex. 6 | yttria | 99 | 30 | alkali glass (alkali metal, 2%)*³ | 100:30 | 900 | 5 | 12^{3} |
| Comp. Ex. 7 | alumina | 99.99 | 30 | quartz at 99.99% purity | 100:10^{3} | 1600 | 1 | 4 |
| Comp. Ex. 8 | alumina | 99.99 | 30 | quartz at 99.99% purity | 100:70^{3} | 1600 | 1 | 4 |
| Comp. Ex. 9 | alumina | 99.99 | 200 | quartz at 99.99% purity | 100:10^{3} | 1600 | 1 | 4 |
| Comp. Ex. 10 | alumina | 99.99 | 1 | quartz at 99.99% purity | 100:5^{3} | 1600 | 1 | 4 |
| Comp. Ex. 11 | alumina | 99.99 | 1 | quartz at 99.99% purity | 100:80^{3} | 1600 | 1 | 4 |

| | | average | | criterion for pass | | |
|---|---|---|---|---|---|---|
| | open | pore | pressure | ⁴ | ⁵ | |
| | porosity | diameter | loss | fracture by | uniform dispersi- | |
| | (%) | (μm) | (×10³ Pa) | microwaves | bility of gas | |
| Example 1 | 28 | 22 | 3.73 | ∘ | ∘ | |
| Example 2 | 26 | 20 | 4.00 | ∘ | ∘ | |
| Example 3 | 24 | 18 | 4.13 | ∘ | ∘ | |
| Example 4 | 22 | 16 | 4.53 | ∘ | ∘ | |
| Example 5 | 40 | 87 | 0.4 | ∘ | ∘ | |
| Example 6 | 38 | 53 | 1.47 | ∘ | ∘ | |
| Example 7 | 31 | 42 | 2.27 | ∘ | ∘ | |
| Example 8 | 26 | 20 | 3.87 | ∘ | ∘ | |
| Example 9 | 37 | 47 | 1.60 | ∘ | ∘ | |
| Example 10 | 26 | 20 | 3.87 | ∘ | ∘ | |
| Example 11 | 26 | 20 | 4.00 | ∘ | ∘ | |
| Example 12 | 46 | 1 | 10.93 | ∘ | ∘ | |
| Example 13 | 44 | 1 | 9.47 | ∘ | ∘ | |
| Example 14 | 37 | 51 | 0.67 | ∘ | ∘ | |
| Example 15 | 39 | 5 | 5.87 | ∘ | ∘ | |
| Example 16 | 26 | 33 | 3.87 | ∘ | ∘ | |
| Example 17 | 27 | 34 | 4.00 | ∘ | ∘ | |
| Comp. Ex. 1 | 26 | 20 | 2.67 | x fractured | ∘ | |
| Comp. Ex. 2 | 49 | 0.3 | 1^{3} | ∘ | x | (gas did not flow) |
| Comp. Ex. 3 | 37 | 48 | 1.47 | x fractured | ∘ | |
| Comp. Ex. 4 | 50 | 150³ | 0.04^{3} | x fractured | x | (not uniform) |
| Comp. Ex. 5 | 42 | 130^{3} | 0.07^{3} | x fractured | x | (not uniform) |
| Comp. Ex. 6 | 29 | 33 | 3.60 | x fractured | ∘ | |
| Comp. Ex. 7 | 66^{3} | 46 | 0.08^{3} | ∘ | x | (not uniform) |
| Comp. Ex. 8 | 11^{3} | 15 | 1^{3} | ∘ | x | (gas did not flow) |
| Comp. Ex. 9 | 52 | 90 | 0.10^{3} | ∘ | x | (not uniform) |
| Comp. Ex. 10 | 70^{3} | 3 | 2.0 | ∘ | x | (not uniform) |
| Comp. Ex. 11 | 9^{3} | 130^{3} | 1^{3} | ∘ | x | (gas did not flow) |

^{1}with no gas permeability, not permeating gas
^{2}Average particle diameter was determined either by particle diameter distribution measuring method according to laser deflection by scattering method, or sieving method
*³Area out of the range of the invention
^{4}Upon evaluation by apparatus in FIG. 2, “∘” shows condition with no crack damages to edge portion and “x” shows condition with damages
^{5}Upon evaluation by apparatus in FIG. 3, “∘” shows condition where gas is dispersed uniformly and “x” shows condition with no uniform dispersion.

As apparent from the above Table 1, in case where the dielectric loss tangent exceeded 1×10⁻³, damages to the edge portion due to cracks were observed in the specimens after application of microwaves.

For the gas dispersion, in case where the pressure loss was lower than 133 Pa, discharge was conducted only from the vicinity of the jetting portion. Thus, a uniform dispersion state was not obtained.

Further, also in case where the open porosity was 60% or more and the pore diameter was 100 μm or more, no uniform discharge was attained.

On the other hand, in case where the open porosity was less than 15%, there was no gas permeability.

It is seen that the dielectric loss tangent was low, for example, in Examples 1 to 4 with high purities of the material particles (alumina purity at 99.99%) and the bonding material (quartz purity at 99.99%), and that the dielectric loss tangent became higher as the purity of the material particles and the bonding material was lower, for example, in Example 8 (alumina purity, 99%), Comparative Example 1 (bonding material: a product containing 2% alkali metal), and Comparative Example 3 (alumina purity: 96.5%).

Further, for the frequency, it was found out that the dielectric loss tangent was higher in a 3 GHz band. However, there was no change in the tendency depending on the purity. The dielectric loss tangent was lower as the purity of product was higher.

From Examples 1 to 4 (bonding material; 15, 30, 45, 60 wt %), it was found out that the open porosity and the average pore diameter were smaller and the pressure loss was higher as the amount of the bonding material was larger.

From Example 2 (average particle diameter 30 μm), Example 5 (average particle diameter 300 μm), Example 6 (average particle diameter 110 μm), Example 7 (average particle diameter 60 μm), and Comparative Example 5 (starting material particle diameter 1000 μm), it was found out that the open porosity and the average pore diameter were larger and the pressure loss was lowered as the average particle diameter of the starting material was larger.

In each of the examples, the pressure loss was 133 Pa or higher, the gas was dispersed uniformly, and three red circles were evenly seen cloudy when the gas was caused to flow at a flow rate of 1 cc/min/cm². On the other hand, in Comparative Examples 4, 5, 7, 9, and 10, the pressure loss was lower than 133 Pa. Therefore, white smoke from the gas jetting ports was dense and the red circle at the center was observed more clearly as compared with other two circles. Thus, it was found out that the gas did not flow uniformly.

As has been described above, the porous member (porous material) manufactured by using the invention has low dielectric loss tangent. Therefore, fracture due to local heating by microwaves is not caused and the pressure loss has a certain level or higher so that the gas can be dispersed uniformly. In the prior art, since the dielectric loss tangent could not be suppressed or the pressure loss was low, it was difficult to control the gas flow rate.

Further, by the use of the invention, for example, in the drying step using microwave heating, a gas can be caused to flow uniformly with no fracture caused by local heating of the gas dispersion plate (porous portion).

### INDUSTRIAL APPLICABILITY

The porous member according to the invention is applicable to porous members used as parts and members for use in environments requiring energy saving and uniform gas flow rate, such as in dry process of electronic devices, production of medical products, and processing and production of foods.

1-20. (canceled)

21. A porous member formed of porous ceramics and having a dielectric loss tangent of 1×10⁻³ or less in a microwave band, an open porosity of 15 to 60%, and an average pore diameter of 10 to 25 μm.

22. The porous member according to claim 21, wherein the pressure loss is 133 Pa or higher at a flow rate of 1 to 10 cc/min/cm².

23. The porous member according to claim 21, containing at least one of oxides of Al, Si, and Y.

24. A method of manufacturing a porous member, which includes blending a starting ceramic powder with an average particle diameter of 1 to 300 μm and a bonding material comprising glass at a blending ratio of 100:15 to 100:60 by weight to prepare a slurry and burning the same at 1550° C. to 1700° C.

25. The method according to claim 24, wherein the blending ratio is from 100:30 to 100:45.

26. The method according to claim 24, wherein the average particle diameter of the starting ceramic powder is from 10 to 40 μm.

27. The method according to claim 24, wherein the starting ceramic powder comprises at least one of oxides of Al, Si, and Y, and the bonding material comprises at least one of quartz glass and non-alkali glass.

28. The method according to claim 27, wherein the starting ceramic powder is alumina or yttria, and the bonding material comprises quartz glass with an average particle diameter of from 1 to 10 μm.

29. A method of manufacturing a ceramic member by using the method of manufacturing a porous member according to claim 24, wherein the method includes filling the slurry to dense sintered ceramics and burning them.

30. The method according to claim 29, wherein the blending ratio is from 100:30 to 100:45.

31. The method according to claim 29, wherein the average particle diameter of the starting ceramic powder is from 10 to 40 μm.

32. The method according to claim 29, wherein the starting ceramic powder comprises at least one of oxides of Al, Si, and Y, and the bonding material comprises at least one of quartz glass and non-alkali glass.

33. The method according to claim 32, wherein the starting ceramic powder is alumina or yttria, and the bonding material comprises quartz glass with an average particle diameter of from 1 to 10 μm.
